(19) United States
(12) Patent Application Publication
(10) Pub. No.: US 2010/0095974 A1
(43) Pub. Date: Apr. 22, 2010

(54) Tool for applying hair color

(76) Inventor: Catherine Ann Laje, El Paso, TX (US)

Correspondence Address: Larry E Severin, Esq, 3581 Teaberry Circle, Seal Beach, CA, 90740, US

(21) Appl. No.: 12/568,780

(22) Filed: Sep. 29, 2009

Related U.S. Application Data
(60) Provisional application No. 61/107,165, filed on Oct. 21, 2008.

(51) Int. Cl. A61Q 5/10; A45D 19/00

(52) U.S. Cl. 132/208; 132/200; 132/270

(57) ABSTRACT

A tool for applying hair color other spreadable material to strands of hair includes: a handle having first and second ends; a point at the first end of the handle for separating the strands; a semi-rigid insert at the second end of the handle; and a flat, semi-flexible, head, attached to the insert, for spreading the spreadable material onto the strands. The head and point are utilized to apply the spreadable material to the strands.

### RELATED APPLICATIONS

The present application claims benefit of priority from U.S. Provisional Application No. 61/107,165, filed Oct. 21, 2008, which is incorporated herein by reference in its entirety.

### BACKGROUND OF THE INVENTION

The present invention generally relates to coloring hair and more specifically to a tool for applying hair color.

Existing hair colorist brush tools are immersed in a hair colorant or bleaching agent and are then used to paint the desired stands of hair. Existing hair colorist blade tools spread a hair colorant on the desired stands of hair. Excess hair colorant is then scraped off. In some cases, the hair that has had hair colorant applied is wrapped in material such as aluminum foil to isolate adjacent hair from contact with such applied hair colorant.

Existing tools include an applicator with the head shaped like a blade or brush. Current devices do not manipulate spreadable materials as well. One must reapply hair color several times.

It would be desirable to have a device that requires only one application of hair color, therefore, saving time and product waste.

### SUMMARY OF THE INVENTION

In one aspect of the present invention, a device for applying spreadable material to strands includes: a handle having first and second ends; a point at the first end of the handle for separating the strands; a semi-rigid insert at the second end of the handle; and a flat, semi-flexible, head, attached to the insert, for spreading the spreadable material onto the strands; wherein the head and point are utilized to apply the spreadable material to the strands.

In another aspect of the present invention, device for applying spreadable material to strands utilizing an applicator head includes: a handle having a first end, a second end, and a grasping area; a point at the first end of the handle for separating the strands; and a semi-rigid insert at the second end of the handle, adapted to engage with and retain the head; wherein the handle is grasped and the head and point are utilized to apply the spreadable material to the strands.

In yet another aspect of the present invention, a method for providing a tool to apply spreadable material to strands includes: providing a handle having first and second ends; providing a point at the first end of the handle adapted to separate the strands; providing a semi-rigid insert at the second end of the handle; and providing a flat, semi-flexible, head attached to the insert and adapted to spread the spreadable material; thereby providing a tool to apply spreadable material to strands.

### BRIEF DESCRIPTION OF THE DRAWINGS

FIG. 1A is a perspective view of an embodiment of the present invention;

FIG. 1B is a top view of the embodiment depicted in FIG. 1A;

FIG. 1C is a side view of the embodiment depicted in FIG. 1A;

FIG. 2A is a perspective view of an embodiment of the present invention, depicting the insert;

FIG. 2B is a top view of the embodiment depicted in FIG. 2A;

FIG. 2C is a side view of the embodiment depicted in FIG. 2A;

FIG. 2D is a left side view of the embodiment depicted in FIG. 2A;

FIG. 2E is a right side view of the embodiment depicted in FIG. 2A;

FIG. 3A is a perspective view of a flat semi-flexible rounded head according to the present invention;

FIG. 3B is a top view of the embodiment of a head depicted in FIG. 3A;

FIG. 3C is a side view of the embodiment of a head depicted in FIG. 3A;

FIG. 4A is a perspective view of an embodiment of the present invention, with the head attached;

FIG. 4B is a top view of the embodiment depicted in FIG. 4A;

FIG. 4C is a side view of the embodiment depicted in FIG. 4A;

FIG. 4D is a left side view of the embodiment depicted in FIG. 4A; and

FIG. 4E is a right side view of the embodiment depicted in FIG. 4A.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the invention generally provides a hair colorist tool for manipulating and controlling spreadable hair color materials.

Embodiments of the present invention include a hair colorist tool for efficient and effective control of spreadable materials. Such a tool may be used for applying spreadable hair color materials to the surface of strands of hair for the purpose of highlighting or coloring hair. An embodiment may maintain pliability and firmness during use, create less product waste, and be cleanable. Embodiments may help prevent hair color getting caught between brush bristles, which would cause the brush not to apply color smoothly onto the scalp or hair strands.

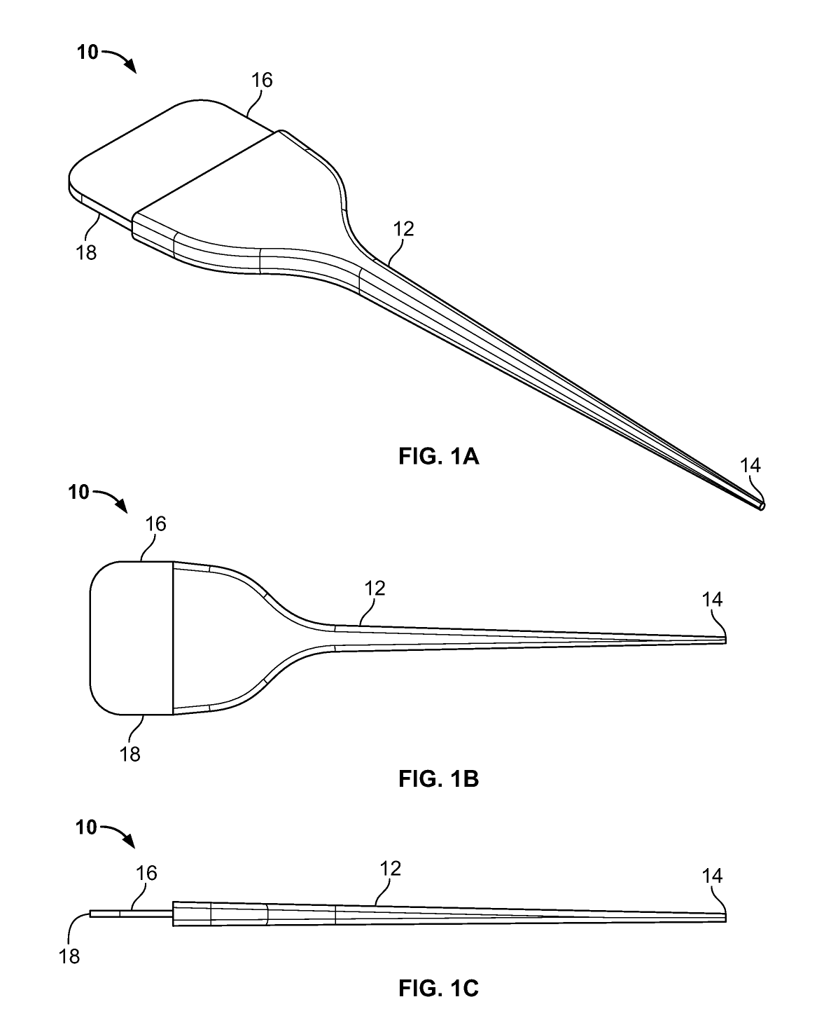

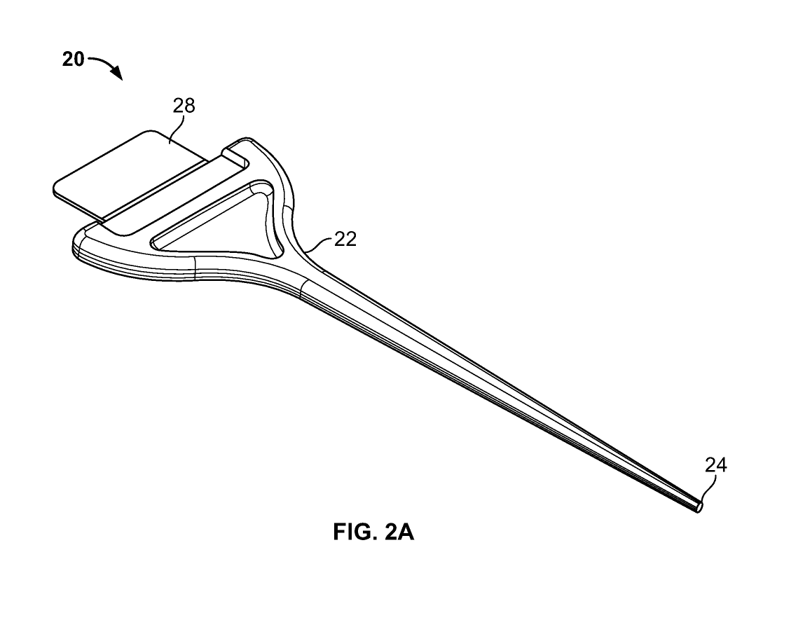

As depicted in FIGS. 1A, 1B, and 1C, an embodiment of the present invention 10 is a hair colorist tool that includes the following elements: a flat handle base 12 with a handle point 14, and a flat semi-flexible rounded head 16 containing a semi-rigid thin plastic insert 18. The head 16 is attached to the handle base 12. The handle base 12 is pointed at the end 14 and may be manufactured from hard plastic or similar material. The head 16 may be manufactured from a semi-flexible single celled polyurethane material or similar material containing a semi-rigid thin plastic insert 18. The head 16 is coupled to the handle base 12.

In embodiments, the head may be fixed to the insert, or the insert may be fixed to the handle, in that the component is attached so that it will not easily fall off. For example, it may be a single piece, or permanently bonded together, or it may also be releasable for maintenance purposes, such as with screws. Some components may be releasably attached, and then removed. For example, the head might be a reusable head that can be removed without damage for cleaning and re-use, or it could be a disposable head that is destroyed when it is removed to allow another head to be attached.

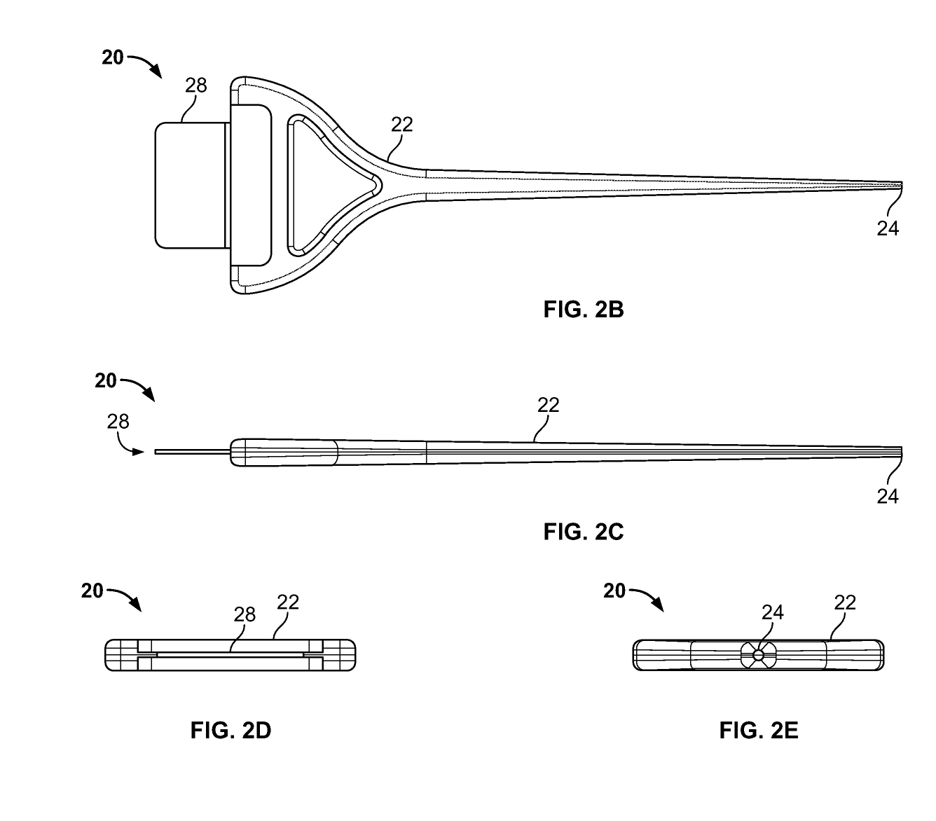

As depicted in FIGS. 2A, 2B, 2C, 2D, and 2E, an embodiment of the present invention 20 is a hair colorist tool that includes the following elements: a flat handle base 22 with a handle point 24, and a semi-rigid thin plastic insert 28. In this embodiment, the insert 28 is fixed to the handle base 22. The flat semi-flexible rounded head 26 (not shown in FIGS. 2A-2E) is releasably attached to the insert 28.

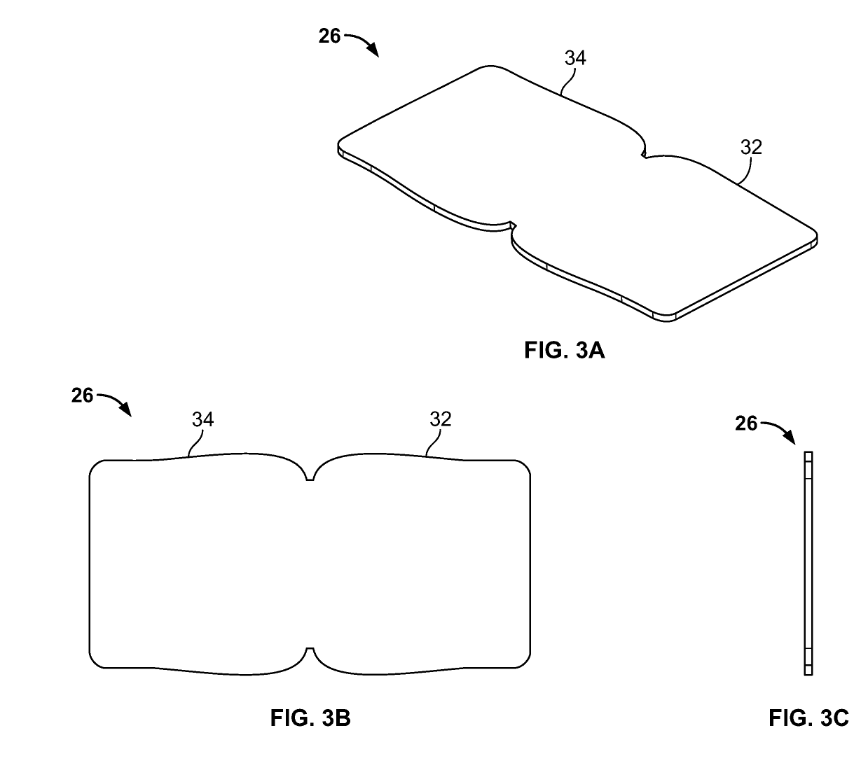

As depicted in FIGS. 3A, 3B, and 3C, an embodiment of a head 26 according to the present invention is a semi-rigid thin plastic insert that could be made of single celled polyurethane material or other material that is suitable to retain and apply hair color. Head 26 includes a first, upper section 34 and a second, lower section 36.

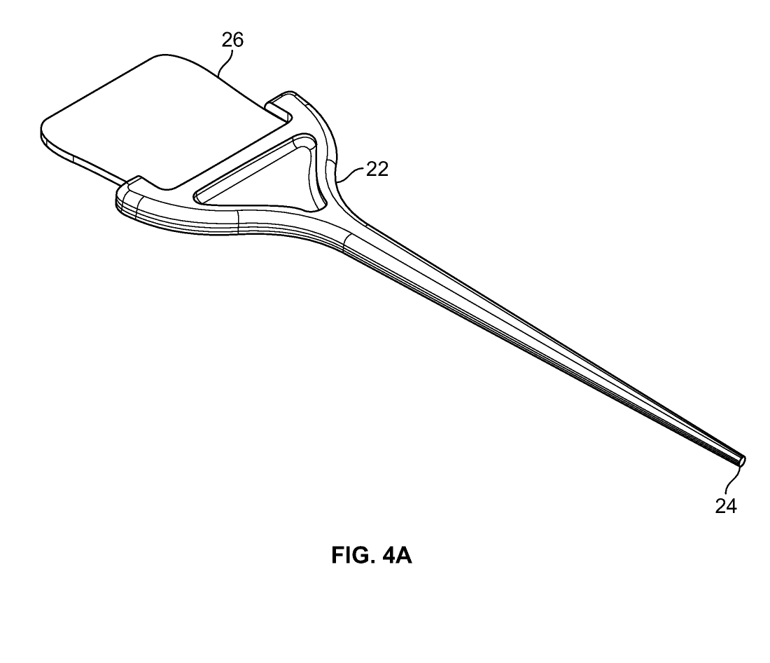

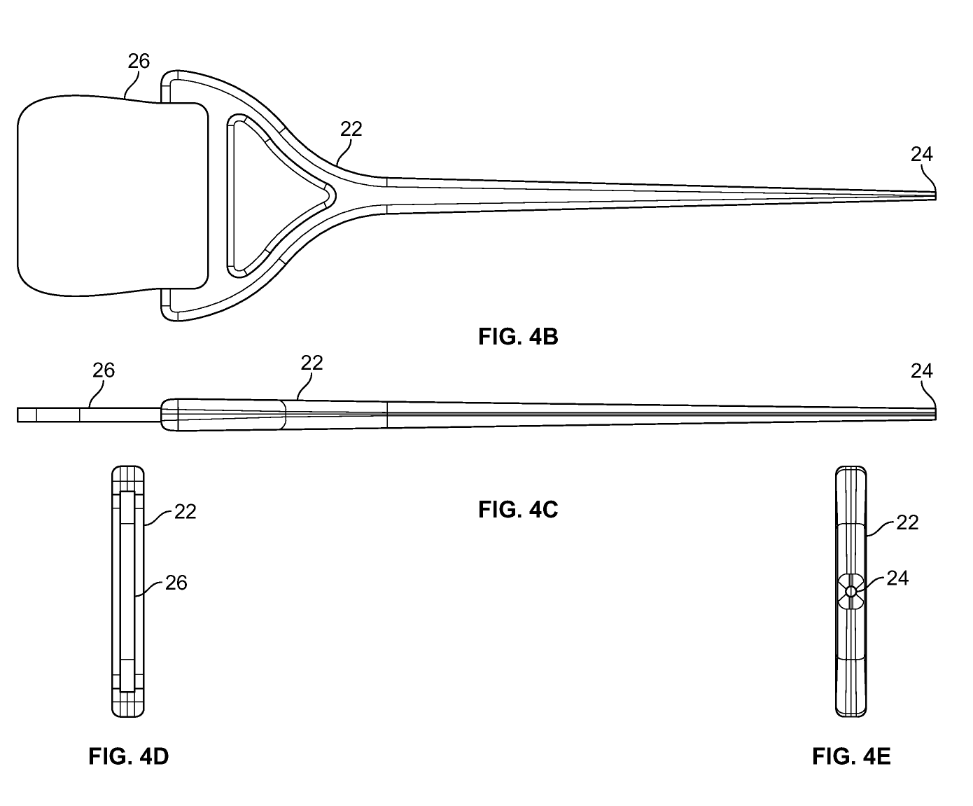

As depicted in FIGS. 4A, 4B, 4C, 4D, and 4E, an embodiment of the present invention 20 includes the following elements: a flat handle base 22 with a handle point 24, a semi-rigid thin plastic insert 28 (not shown in FIGS. 4A-4E), and a flat semi-flexible rounded head 26.

In one method of manufacturing an embodiment, a handle base with a handle point is manufactured by injection molding. The mold is designed to create the shape of the handle and to incorporate attachment of the head containing the insert. Hard plastic or similar material is injected into the mold to create the handle. Another method of manufacturing is to cut the handle from said materials sheets utilizing laser or water cutting manufacturing methods.

In one method of manufacturing an embodiment, a flat semi-flexible rounded head containing a semi-rigid thin plastic insert is manufactured by injection molding. The mold is designed to create the shape of the head and plastic insert. Single celled polyurethane material or similar material is injected into the mold around the plastic insert to create the head. Another method of manufacturing is to cut the head from said materials sheets utilizing laser or water cutting manufacturing methods, then compressing said plastic insert within outer said materials.

An embodiment of a flat semi-flexible rounded head may allow for a precise application of spreadable material such as hair color. The head contains a plastic insert that increases flexibility and control of the head. The spreadable material is spread on a surface via the head.

In an embodiment, the head and the point of the handle cooperate to apply the materials in that the user can grasp the tool in one hand, use the flexible head to apply the hair color, then immediately use the point to separate the hairs. This helps spread the hair color evenly over all portions of the hair to be colored.

In an embodiment, the insert is a tab or other retaining member at the end of the handle. It may be permanently fixed or releasably attached to the handle. The handle is generally flat, in that it is mostly planar. It could be smooth, or could have ridges or patterns to improve grip or adhesion. The handle and head could be other shapes and sizes that those shown the figures.

I claim:

1. A device for applying spreadable material to strands, comprising:
a handle having first and second ends;
a point at the first end of the handle for separating the strands;
a semi-rigid insert at the second end of the handle; and
a flat, semi-flexible, head, attached to the insert, for spreading the spreadable material onto the strands;
wherein the head and point are utilized to apply the spreadable material to the strands.

2. The device of claim 1, wherein the spreadable material is hair color and the strands are hair.

3. The device of claim 1, wherein the head is fixed to the insert, and the insert is releasably attached to the second end of the handle.

4. The device of claim 1, wherein the insert is fixed to the second end of the handle, and the head is releasably attached to the insert.

5. The device of claim 1, further comprising:
a generally flat, first surface of the insert;
a generally flat, second surface of the insert;
a generally flat, first surface of the head to attach to the first surface of the insert; and
a generally flat, second surface of the head;
wherein the second surface of the insert and the second surface of the head are utilized to apply the spreadable material.

6. The device of claim 1, further comprising:
a generally flat surface of the insert;
a generally flat surface of the head;
an adhesive;
wherein the adhesive attaches the surface of the insert to the surface of the head.

7. The device of claim 1, the head having a cavity and the insert extending beyond the second end of the handle to engage with the cavity so as to retain the head.

8. The device of claim 1, the head further comprising:
a sheet of flat, semi-flexible material, having an upper section that attaches to an upper surface of the insert, and a lower section that attaches to a lower surface of the insert.

9. The device of claim 1, wherein the head further comprises single-cell polyurethane.

10. The device of claim 1, wherein the head further comprises generally rounded corners.

11. The device of claim 1, wherein the spreadable material is hair color, the strands are hair, and the head further comprises:
a sheet of material adapted to retain and apply hair color; and
generally rounded corners to help spread the hair color onto the strands of hair.

12. The device of claim 1, further comprising:
a generally flat, upper surface of the handle; and
a generally flat, lower surface of the handle;
wherein the upper surface and the lower surface of the handle cooperate to form a graspable area of the handle.

13. A device for applying spreadable material to strands utilizing an applicator head, comprising:
a handle having a first end, a second end, and a grasping area;
a point at the first end of the handle for separating the strands; and
a semi-rigid insert at the second end of the handle, adapted to engage with and retain the head;
wherein the handle is grasped and the head and point are utilized to apply the spreadable material to the strands.

14. The device of claim 13, wherein:
the applicator head is made of flat, semi-flexible material having a cavity; and
a portion of the insert extends beyond the second end of the handle, adapted to engage with the cavity in the head so as to retain the head.

15. The device of claim 13, wherein the spreadable material is hair color and the strands are hair.

16. A method for providing a tool to apply spreadable material to strands, comprising:
providing a handle having first and second ends;
providing a point at the first end of the handle adapted to separate the strands;
providing a semi-rigid insert at the second end of the handle; and
providing a flat, semi-flexible, head attached to the insert and adapted to spread the spreadable material;
thereby providing a tool to apply spreadable material to strands

17. The method of claim 16, further comprising:
making the handle having the point at the first end of the handle;
making the head containing the insert; and
attaching the head containing the insert to the second end of the handle.

18. The method of claim 16, further comprising:
making the handle having the point at the first end of the handle and the insert at the second end of the handle;
making the head; and
attaching the head to the insert.

19. The method of claim 16, further comprising:
making the handle having the point at the first end of the handle and the insert at the second end of the handle, the insert having an upper surface and a lower surface;
providing a sheet of flat, semi-flexible material;
cutting the sheet so as to make the head having an upper section and a lower section;
attaching the upper section of the head to the upper surface of the insert; and
attaching the lower section of the head to the lower surface of the insert.

20. The method of claim 16, further comprising:
separating the strands utilizing the point; and
spreading the spreadable material onto the strands utilizing the head.
